(19) United States
(12) Patent Application Publication
(10) Pub. No.: US 2006/0279210 A1
(43) Pub. Date: Dec. 14, 2006

(54) Tungsten-filament bulb

(76) Inventors: Ching-Chu Chen, Hsinchu (TW); Chin-Li Tsai, Hsinchu (TW); Shu-Mei Tai, Hsinchu (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/149,321

(22) Filed: Jun. 10, 2005

(51) Int. Cl. H01K 1/50; H01K 1/00; H01K 1/02

(52) U.S. Cl. 313/579; 313/578; 313/341; 313/315

(57) ABSTRACT

A tungsten-filament bulb includes a filament set inside a housing. At least two magnesium-plated filaments of the filament extend through a stem of the housing. A tip of the housing forms a minute orifice for evacuating air from the housing to create a vacuum. A light cap is secured below a stem of the housing. The light cap includes an electrical contact base electrically connected to the magnesium-plated filaments of the filament set. With a design of the above-mentioned orifice in the tip of the housing, a conventional manufacturing defect of a deformation can be avoided when fabricating the housing with a column together by heating.

### BACKGROUND OF THE INVENTION

1. Field of the Invention

The invention relates in general to a tungsten-filament bulb, and more particularly to a tungsten-filament bulb that can effectively avoid defective products being made during manufacture.

2. Description of the Related Art

Although plenty of energy-efficient electrical illumination appliances are available in the market, a tungsten-filament bulb still possesses a proportionate market share. This is because the tungsten-filament bulb has advantages of a low price and that the light is not harmful to the eyes. Although the tungsten-filament bulb has the low price advantage, a manufacturing efficiency must still be enhanced to maximize its key advantage as cost improvements will inevitably occur with the development of its competitors. However, conventional manufacturing processes are restricted within a particular structure mold. Hence a conventional manufacturing technique can be further improved.

Referring to FIG. 5, a cross-sectional side view of an example of a conventional tungsten-filament bulb is shown. A vacuum is formed inside a housing 80. An opening of the housing 80 is integrated with a light cap 81. The light cap 81 can be connected with a lamp holder.

Referring to FIG. 6, a column 82 made of insulating materials such as glass is fitted inside the housing 80. A button 820 is formed on a top of the column 82. Three cantilevers 85 uprightly extend on the button 820. Two magnesium-plated filaments 831 and 832 uprightly extend through the column 82. In this way, tops of the two magnesium-plated filaments 831, 832 and the cantilevers 85 are coupled to a coiled tungsten-filament 84.

The column 82 is conventionally made of glass. In the conventional manufacturing processes, the column 82 and the housing 80 are manufactured separately. When assembling the bulb, the column 82 is put inside the housing 80 from the opening at a bottom of the housing 80. Then a joint location of the column 82 and the housing 80 is heated to fuse the both. However, the aforesaid manufacturing process tends to produce defective products because the housing 80 has to be heated for the second time when fabricating the housing 80 and the column 82 together. Since the housing 80 is made of the blown-molded glass, the housing 80 has been heated for a first time to be blown and then is cooled to take shape. The reheated housing 80 is particularly fragile. Moreover, if the opening of the housing 80 requires larger arc angles in terms of a shape, the housing 80 tends to deform and thus becomes the defective product.

### SUMMARY OF THE INVENTION

It can be understood from the above-described prior art that despite the conventional bulbs having the advantage of low price; the conventional manufacturing processes tend to produce defective products. It is therefore an objective of the present invention to provide a tungsten-filament bulb that can effectively avoid the tungsten-filament bulb deforming during manufacturing.

In order to achieve the above-mentioned objective, a tungsten-filament bulb mainly includes a filament set, a housing and a light cap. The filament set includes at least two magnesium-plated filaments extending through an insulator. A coiled tungsten filament is coupled to the two magnesium-plated filaments. The housing is made of a blown-molded glass. The housing includes a stem and a tip. The magnesium-plated filaments of the filament set extend through the stem of the housing. The tip of the housing forms a minute orifice for evacuating air to create a vacuum inside the housing. The light cap is secured below a stem of the housing. The light cap includes an electrical contact base to be electrically connected to the magnesium-plated filaments of the filament set. The filament set further includes at least one support wire extending through the insulator. The support wire is longer than the magnesium-plated filaments, so as to support the coiled tungsten filament coupled with the two magnesium-plated filaments.

According to the above-described bulb structure of the present invention, the filament set is put inside the encompassing housing to make the magnesium-plated filaments extend through the stem of the housing during the process of blown-molded the housing. The orifice of the housing is formed at the tip for evacuating air to create a vacuum. After the vacuum is formed inside the housing, the orifice at the tip is sealed. In this way, the housing does not need to be heated twice, so as to avoid a deformation of the housing and the column during the conventional reheating process.

### BRIEF DESCRIPTION OF THE DRAWING

FIG. 1 shows a perspective view of a first preferred embodiment of the present invention.

FIG. 2 shows a cross-sectional side view of the embodiment of FIG. 1.

FIG. 3 shows a perspective view of a second embodiment of the present invention.

FIG. 4 shows a cross-sectional side view of the embodiment of FIG. 3.

FIG. 5 shows a cross-sectional side view of a conventional tungsten-filament bulb.

FIG. 6 shows a perspective view of the conventional tungsten-filament bulb.

### DETAILED DESCRIPTION OF THE INVENTION

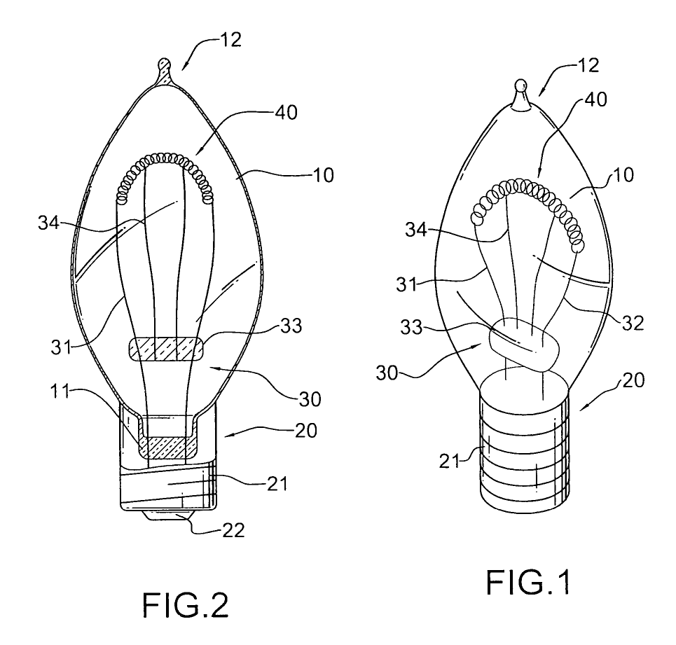

Referring to FIG. 1 and FIG. 2, a perspective view and a cross-sectional side view of a first example of a preferred embodiment of the present invention are shown. A tungsten-filament bulb includes a filament set 30, a housing 10 and a light cap 20. The filament set 30 includes at least two magnesium-plated filaments 31, 32 extending through an insulator 33. A coiled tungsten filament 40 is coupled to the two magnesium-plated filaments 31, 32. In this preferred embodiment of the present invention, the filament set 30 further includes two support wires 34 extending through the insulator 33. The support wires 34 are longer than the magnesium-plated filaments 31 and 32, so as to support the coiled tungsten filament 40 and also make the tungsten filament 40 to be coiled to an appropriate length.

The housing 10 is made of a blown-molded glass. The housing 10 includes an airtight stem 11 and a tip 12. The magnesium-plated filaments 31, 32 of the filament set 30 extend through the stem 11. The tip 12 defines a minute orifice for evacuating air from the housing to create a vacuum.

The light cap 20 is secured below the stem 11 of the housing 10. The light cap 20 includes contacts 21 and 22 formed respectively at a cylindrical exterior and a bottom, so as to electrically connect the magnesium-plated filaments 31, 32 of the filament set 30 to an electricity supply. Thereby an electric current can pass through the magnesium-plated filaments 31, 32 to arrive at the tungsten filament 40.

According to the above-described example of the preferred embodiment of the present invention, the filament set 30 is put inside the housing 10 to make the magnesium-plated filaments 31 and 32 extend through the stem 11 of the housing 10 during the process of blow-molding the housing 10. The orifice of the housing 11 is formed at the tip 12 for evacuating air to form the vacuum. After the vacuum is formed inside the housing 10, the orifice at the tip 12 is hermetically sealed.

Since the present invention simplifies a structure of the filament set 30 which dispenses with the conventional column, a fabrication of the filament set 30 and the housing 10 can be completed during the process of blow-molding the housing. With the design of the present invention, the housing 10 does not need to be heated twice, so as to avoid a deformation. Therefore, occurrences of defective products are largely decreased, so as to enhance production capability and reduce manufacturing cost.

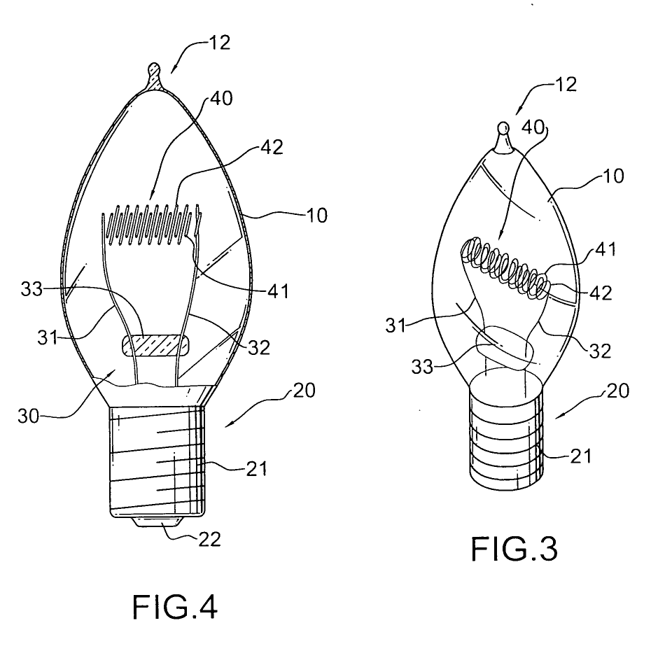

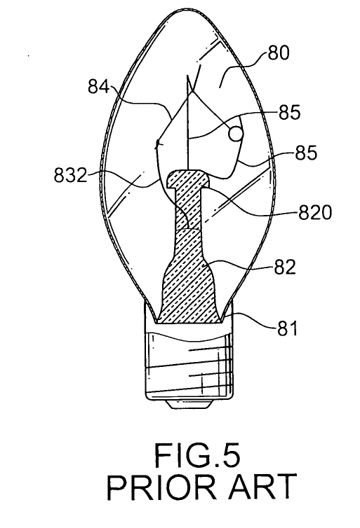

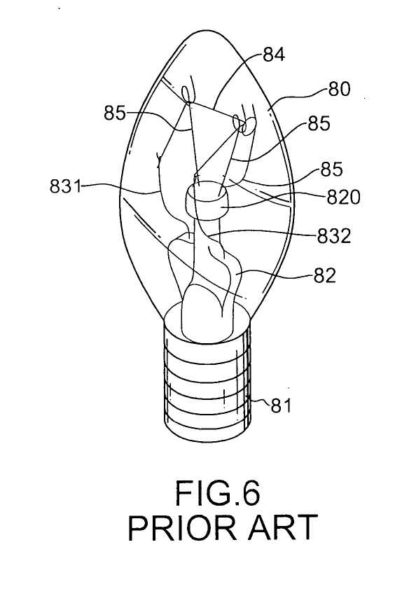

Referring to FIG. 3 and FIG. 4, a second example of a preferred embodiment of the present invention is shown. The structure of the second example of the preferred embodiment is similar to that of the first example of the preferred embodiment. The difference is that the tungsten filament 40 is made of a first helical section 41 and a second helical section 42. The first helical section 41 and the second helical section 42 form a double helix along an axis of a hypothetical line which is formed by two tip points of the two magnesium-plated filaments 31 and 32. An outside diameter of the second helical section 42 is larger than the outside diameter of the first helical section 41, which forms a coaxial inner helix and an outer helix. Moreover, the first/second helical sections 41/42 each include a first end and a second end respectively. The first/second ends of the first helical section 41 are coupled respectively to the magnesium-plated filaments 3 land 32. The first end of the second helical section 42 is coupled to the second end of the first helical section 41. The second end of the second helical section 42 is coupled to the first end of the first helical section 41, so as to be coupled to the magnesium-plated filament 31.

While the invention has been described by way of example and in terms of a preferred embodiment, it is to be understood that the invention is not limited thereto. On the contrary, it is intended to cover various modifications and similar arrangements and procedures, and the scope of the appended claims therefore should be accorded the broadest interpretation so as to encompass all such modifications and similar arrangements and procedures.

What is claimed is:

1. A tungsten-filament bulb comprising:
a filament set comprising at least two magnesium-plated filaments extending through an insulator, a coiled tungsten filament coupled to the two magnesium-plated filaments;
a housing made of a blown-molded glass and comprising a stem and a tip, wherein the magnesium-plated filaments of the filament set are embedded in the stem, and the tip is sealed after air is evacuated from the housing to create a vacuum in the housing; and
a light cap secured below the stem of the housing, the light cap comprising an electrical contact base electrically connected to the magnesium-plated filaments of the filament set.

2. The tungsten-filament bulb as claimed in claim 1, wherein the filament set further comprises at least one support wire extending through the insulator, and the support wire is longer than the magnesium-plated filaments to support the coiled tungsten filament coupled with the two magnesium-plated filaments.

3. The tungsten-filament bulb as claimed in claim 1, wherein the tungsten filament is made of a first helical section and a second helical section, wherein the first helical section and the second helical section form a double helix along an axis of a hypothetical line, wherein an outside diameter of the second helical section is larger than the outside diameter of the first helical section, which forms a coaxial inner helix and an outer helix, wherein the first/second helical sections each include a first end and a second end respectively, wherein the first/second ends of the first helical section are coupled respectively to the magnesium-plated filament, wherein the first end of the second helical section is coupled to the second end of the first helical section, and wherein the second end of the second helical section is coupled to the first end of the first helical section, so as to be coupled to the magnesium-plated filament.
